(19) United States
(12) Patent Application Publication
(10) Pub. No.: US 2001/0031448 A1
(43) Pub. Date: Oct. 18, 2001

(54) Method of technical education employing flying objects and flying objects used therefor

(75) Inventors: Toshio Itoh, Tokyo (JP); Katsuhisa Ootsuta, Tokyo (JP); Masayuki Miyazaki, Tokyo (JP); Hiroo Sakamoto, Tokyo (JP); Shiro Tatsumi, Tokyo (JP); Yoshikazu Ugai, Tokyo (JP); Masaharu Sawatani, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Mitsubishi Denki Kabushiki Kaisha, Tokyo (JP)

(21) Appl. No.: 09/883,392

(22) Filed: Jun. 19, 2001

Related U.S. Application Data
(62) Division of application No. 09/373,192, filed on Aug. 12, 1999.

(30) Foreign Application Priority Data
Sep. 21, 1998 (JP) 10-266408

(51) Int. Cl. G09B 9/02

(52) U.S. Cl. 434/29

(57) ABSTRACT

A method of technical education comprising an educational process of simulating behaviors of a flying object through a simulation program of flight functions based on basic equations of hydrodynamics, an educational process of designing the flying object and manufacturing the same, an educational process of confirming behaviors of the flying object through experimentation, and an educational process of optimizing the flying object to present targeted functions. Creative activities for obtaining an improved flying object can be performed during an educational process of experiencing effective and proper designing, manufacturing and test flying of a flying object as a teaching material. With this arrangement, the level of comprehension of hydrodynamics can be heightened from a level of passive comprehension to a level with which intellectual productive activities in the sense of creative activities can be achieved. A technical educational system and a flying object are also disclosed.

### BACKGROUND OF THE INVENTION

The present invention relates to a method of technical education for enabling students understand high level techniques in the technical field of natural science which is considered to be quite difficult, and it also relates to physical functional teaching materials employed in the method.

Conventionally, education was performed through explanations supplied through textbooks and teachers, and alternatively, through additional practices based on exercises of these.

Levels of technical comprehension of students remained to be passive comprehension of written contents of textbooks, and it had been difficult to provide students with technical comprehension of high level that might cause students to actively execute creative activities.

The present invention has been made to solve the above noted problems in the field of conventional technical educational methods, and it is an object of the present invention to provide students with technical comprehension of high level that might cause students to actively execute creative activities based on the comprehension of the technique.

### SUMMARY OF THE INVENTION

The method of technical education according to a first aspect of the present invention comprises the following educational processes.

(a) An educational process of simulating behaviors of a flying object through a simulation program of flight functions based on basic equations of hydrodynamics.

(b) An educational process of designing the flying object and manufacturing the same.

(c) An educational process of confirming behaviors of the flying object through experimentation.

(d) An educational process of optimizing the flying object to present targeted functions.

The system of technical education according to a second aspect of the present invention comprises a device including the followings.

(a) A simulation program for analyzing behaviors of a flying object based on basic equations of hydrodynamics.

(b) An executing means for executing the simulation program for analyzing behaviors of the flying object.

(c) A manufacturing means for manufacturing a physical functional system being oriented to the flying functions.

The flying object which is a physical teaching material according to a third aspect of the present invention satisfies the following conditions.

(1) The flying object should comprise a sheet-like planar constitutional material and a frame material and should be of planar arrangement that can maintain its own shape.

(2) It should comprise main wings and at least horizontal tails.

(3) At least the main wings should assume dihedral angles.

(4) The horizontal tails should assume negative angles of incidence.

(5) The tension center of string at the time of making the object fly as a kite should be positioned closer to the front than the aerodynamic center.

### BRIEF EXPLANATION OF THE DRAWINGS

FIG. 1 is a diagram for explaining flying condition of a kite;

FIG. 2 is a diagram showing positional relationships between angle of incidence and center of wind pressure of kites;

FIG. 3 is a diagram showing the relationship between angle of incidence and lifting force of kites of different cambers;

FIG. 4 is a diagram showing the relationship between wind pressure actuating on conventional kites and angle of incidence;

FIG. 5 is a diagram showing the relationship between vertical component of wind pressure actuating on conventional kites and angle of incidence;

FIG. 6 is a diagram for explaining a flying theory of a flying object with a horizontal tail;

FIG. 7 is a diagram for showing flying characteristics of flying objects with a horizontal tail;

FIG. 8 is a diagram for showing flying characteristics of flying objects with a horizontal tail;

FIG. 9(a) and FIG. 9(b) are diagrams showing examples for configuration of flying objects;

FIG. 10 is a front view showing an example of a configuration of a flying object;

FIG. 11 is a diagram for explaining theory of a framework of a flying object;

FIG. 12(a) and FIG. 12(b) are diagrams for explaining actions of frameworks of flying objects; and

FIG. 13 is a diagram showing a formation method of a tail of the flying object.

### EMBODIMENT 1

1. The method of technical education according to the present invention includes educational processes as follows.

(1) Lectures by Teachers:

This is an educational process of acquiring hydrodynamics and, as required bases thereof, mathematics and dynamics. For students who have already completed these classes, these might be omitted.

(2) Simulation Studies Based on Computation:

Based on basic equations of hydrodynamics, and especially aircraft dynamics, simulation of flight phenomena are performed based on exercises of flying objects for the sake of comprehension of hydrodynamic functions of flying objects of these exercises.

(3) Design and Manufacture of Flying Objects as Physical Teaching Materials:

Flying objects are designed and manufactured based on knowledge obtained through the lectures and simulation studies.

(4) Test Flying of Flying Objects as Teaching Materials:

Experiments are performed to make the flying objects which have been manufactured in the above step fly as kites. Students are made to attempt improvements in flying functions as kites, and by repeating the step of designing and manufacturing as noted in item (3), optimization of flying functions is acquired.

2. Details of the Flying Objects as Teaching Materials

Basic characteristics of the flying objects used as teaching materials in the present invention are as follows.

(1) The flying object comprise a light-weighted sheet and a light-weighted frame material and is of planar arrangement which can maintain its own shape.

(2) It comprises main wings and horizontal tails.

(3) At least the main wings assume dihedral angles.

(4) The horizontal tails assume negative angles of incidence.

(5) The point of connection of the string at the time of making the object fly as a kite is positioned to be closer to the front of the aerodynamic center. In case there are provided a plurality of bridles, a point lying on the extension of a string which is lower than the bridle is positioned to be closer to the front of the aerodynamic center.

A typical kite according to the prior art is of a single planar arrangement which has a negative camber (surface which is convex in a downward direction along an axis) for providing stability against pitching, and presents angles of incidence of approximately 45°. In contrast thereto, the flying object used as a teaching material in the present invention has main wings with positive or zero camber and horizontal tails with negative angles of incidence, wherein stability of pitching is provided by the negative angles of incidence of the horizontal tails. Such a flying object assumes angles of incidence which are by far smaller than those of conventional kites, and this flying object is similar to an airplane which flies under laminar conditions in a substantially horizontal manner. This flying object differs from airplanes in the point that while an airplane aims for minimization of lift-drag ratio and minimization of the amount of fuel consumption, there is little necessity for the flying object of the present invention to make the resistance of the flying object itself small due to the presence of a large horizontal resistance acting on the string, and maximization of lifting force is the only target. Due to this fact, a large degree of freedom is enabled for the planar shape thereof than compared to airplanes, and a large degree of freedom for the optimization of functions as a kite is also enabled. Therefore, it is enabled to manufacture an object which is further optimized as a kite than compared to those in which airplanes have been diverted to kites.

In this manner, it has been enabled to remarkably improve the flying performance of the flying object of the invention than compared to conventional kites. Comparing, for instance, the maximum altitude of elevation with that of a conventional kite, it can be confirmed that conventional kites have been largely improved.

The flying object as a teaching material of the present invention has been highly optimized for application as a kite, and is capable of presenting performances which are close to physical limits. Due to the existence of various losses in systems with many compromises such as a conventional kite, limits of performance are actually generated at a level which is lower than theoretical limits of performance. This means that one cannot meet a chance to actually confirm theoretical limits of performance. In studying theories of natural science, it is extremely effective to actually realize through experience limits of performance of a physical functional system with a specified functional target. For this purpose, the physical functional system is required to be highly optimized for performing the targeted functions.

As explained above, the flying object as a teaching material of the present invention is extremely effective for supporting comprehension of hydrodynamics, and especially aircraft dynamics, which are of a hardly comprehensible technical field.

The arrangement of the flying object as a teaching material and functions thereof will now be explained in details.

2.1 Differences Between the New Flying Object (NFO) and Conventional Flying Objects

While this flying object is similar to conventional kites in the point that it flies in air with being restricted by a string, the style of drifting in air essentially differs from those of conventional kites. Since it is also different from airplanes or gliders due to reasons discussed later, this will be denoted as a New Flying Object (abbreviated as “NFO”). Flying of a typical kite of conventional type is achieved based on a harmonizing condition that one plane which is inclined to oblique forward at a certain angle (angle of incidence) in a direction of wind receives wind pressure in a vertical direction with respect to the plane, and the total sum of these wind pressure values are made competitive to a sum of tension force of the string and own weight (which might be ignored in consideration of the total sum of wind pressure values in ordinary flying conditions).

In contrast to that, the flying object employed here is a flying object close to an airplane which flies by receiving in wind a lifting force in a vertical direction with respect to the wind and a resistance in a horizontal direction which is by far smaller than the lifting force. That is, supposing that wind is presently blowing in a horizontal direction, the vertical components of the tension force of the string is made competitive with the lifting force and gravity of its own weight (which normally is ignorable than compared to the lifting force), and horizontal components of the string is made competitive with the resistance when performing flying. In case the driving force in a forward direction which replace the tension force of the string and load for adjusting the center of gravity is applied, the flying object flies in a forward direction in air in a wind-less condition and forms a flying condition similar to those of airplanes. Depending on the adjustment of the center of gravity, a driving force gliding forward while descending is formed by utilizing the gravity in a forward direction as a driving force and a flying object is obtained which is similar to a glider. However, the NFO differs from an airplane due to the following points.

It is a designing target of an airplane to optimize the lift-drag ratio (ratio between lifting force and resistance) which is proportional to the amount of fuel consumption with respect to a given flying speed, and one of the basis of design is to design the planar shape of main wings to assume optimal, specific shapes in view of this target. Elliptic wings employed in light-weighted airplanes or sweep-back wings employed in Bowing B747 are examples of optimized shapes.

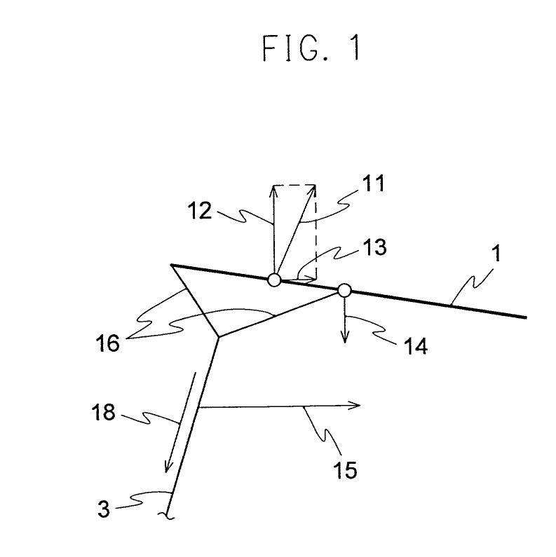

In contrast to that, it is not a target of the flying object of the present invention to minimize the resistance but to raise it as high as possible. FIG. 1 is a diagram for explaining flying conditions of a kite. 1 denotes a main wing, 3 a string, 11 wind pressure, 12 lifting force, 13 resistance of main wing, 14 gravity, 15 resistance of string, 16 a bridle respectively. Moreover, since there is a resistance applied to the string in a wind speed direction as shown in FIG. 1 which is not the case with airplanes, and this resistance is generally larger than the resistance applied to the plane of the flying object, there is little significance in decreasing the resistance of the flying object itself. Thus, in order to achieve the purpose of making the flying object fly high, it is a basis for design to optimize the framework structure which makes it possible to maximize the lifting force rather than to minimize the resistance of the plane.

The degree of freedom for selecting the planar shape will be increased in case of only targeting maximization of lifting force and eliminating the target of minimizing the resistance. That is, an optimal shape for a NFO is different from those for airplanes. Actually, while the lift-drag ratio is highly dependent on the aspect ratio, the lifting force is not necessarily dependent on the aspect ratio. For instance, in case of a wing having a shape of [symbol] of which aspect ratio is small, the lift-drag ratio is inferior to that of an elliptic wing of which aspect ratio is large, while the lifting force of the former becomes rather larger than that of the latter owing to the existence of a nonlinear eddy lifting force (literature: Akira Azuma, “Science of Model Airplanes and Kites”, Denpa Jikken Kabushiki Kaisha, 1992). By recognizing the optimal shape as a kite in such a manner, it will be possible to design a flying object which is of superior flying performance as a kite rather than those in which designs for airplanes have been diverted.

Since selection of planar shapes can be freely performed for a NFO in contrast to airplanes, it will be a basis of design to first create a planar shape which one aims to lift and then to optimize the structure of framework of this shape in view of the target of making the same fly high.

2.2 A Condition for Enabling a Single Plane Fly

In a planar structure which is generally restricted by a string and which flies at a certain angle of incidence, the following conditions are met with the bridle being the center.

(1) The wind pressure which is the sum of resistance and lifting force is competitive with the sum of tension force and gravity.

(2) The moment due to aerodynamics in the periphery of the bridle and the moment due to gravity are competitive with each other.

In order to satisfy these conditions, the center of wind pressure needs to be closer than the gravity and the bridle closer than the center of wind pressure with respect to the front end (tip) of the respective planes as shown in FIG. 1 for making the kite fly. However, since the gravity is by far smaller than the aerodynamics under ordinary conditions for flying as already discussed, the above conditions might be replaced by more simple conditions as follows:

(1) The center of bridle (point at which an extension of the string intersects with the plane of the kite) is substantially coincident with the center of wind pressure.

(2) Tension force is competitive with wind pressure.

The following explanations are based on the supposition that the center of wind pressure is coincident with the center of the bridle.

Here, a plane having a large aspect ratio and of small thickness like wings of a bird or an airplane is considered to be a flying object. In this case, as recited in the Mechanical Engineering Handbook Ver. 1996, Page A5-109, the nondimensional lifting force coefficient CL and the moment coefficient Cmac in the periphery of the aerodynamic center (a point at which the moment caused by aerodynamic force becomes constant regardless of the angle of incidence; and in this case, a point being located at a distance of wing arc÷4 from the tip of the plane) is given by the following equations in case the angle of incidence α is small:

CL=2π(Sin [α]+2f) (Equation 1)

Cmac=−πf (Equation 2)

Here, f indicates an amount of bend of the plane (camber) and is obtained by dividing a height of maximum expanded point of the wing from a line connecting a front edge and a rear edge by the wing arc. In case of wings as those of airplanes in which the plane is bent upward in a concave manner, f becomes positive, and in case of those in which it is bent downward in a concave manner like a ship bottom, f becomes negative.

Further, CL and Cmac are nondimensional amounts satisfying the following relationship with respect to lifting force L and moment Mac (which is positive when the rear edge faces down).

CL=L/(1/2ρU²S) (Equation 3)

Cmac=Mac/(1/2ρU²S) (Equation 4)

Here, U denotes wind speed, S area of plane, and ρ density of air.

In case the nondimensional distance obtained by dividing the distance from the aerodynamic center to the center of wind pressure, that is, the center of the bridle, is set to x (positive from the aerodynamic center toward the rear edge side), x might be obtained from the following equation.

−xCL=Cmac

Note that x is positive from the front edge towards the rear edge, and satisfies x=0 at the aerodynamic center.

By assigning CL and Cmac of Equation 1 and Equation 2 into CL and Cmac of the above equation, x can be obtained as follows.

x=f/(2(Sin α+2f)) (Equation 5)

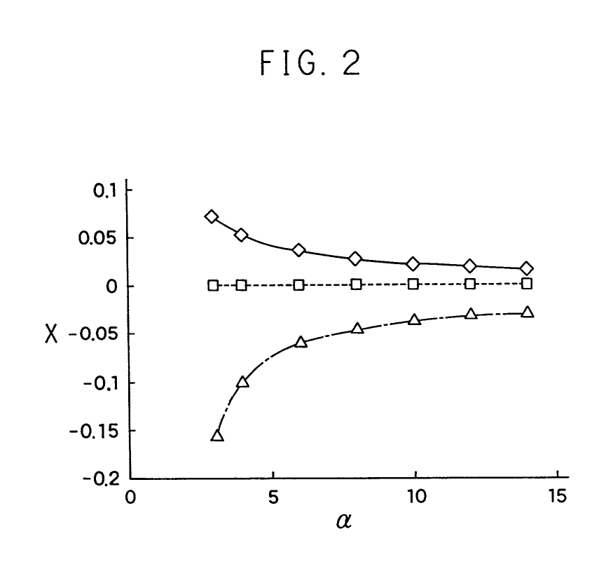

FIG. 2 is a diagram showing the relationship between α and x wherein α is taken on the lateral axis and x on the vertical axis. The solid line in the drawings denotes a case in which f=0.01 is satisfied, that is, f is positive (called a wing of positive camber and is employed in subsonic airplanes), the broken line in which f=0 and the one dot chain line in which f=−0.01 is satisfied, that is, f is negative.

According to characteristics of wings of positive camber, a decrease in angle of incidence α causes a shift of the center of wind pressure to the direction of the rear edge. Consequently, a moment is actuated which further decreases the angle of incidence so that the kite falls forward and finally crashes. In case of a plane of zero camber, no moment for restoring such a condition is actuated so that it cannot be recovered once it has been inclined. In other words, with a plane of zero or positive camber, flying cannot be performed in the prevailing condition (Reference: Toshiro Itoh & Koji Komura, “Science of Kite”, Kabushiki Kaisha Shogakukan, 1979). Such a phenomenon is called a “phenomenon of static instability related to the pitching of kites”.

In contrast to that, in case of a plane of negative camber, a decrease in a causes a shift of the center of wind pressure to the direction of the front edge, and a moment is actuated for restoring α. Therefore, a plane of negative camber is capable to fly as it is.

The above conditions also apply for airplanes or gliders as well as wings of small aspect ratios, and leads to a rule that “the only plane which is capable of performing flying without the provision of horizontal tails is a wing of negative camber”. Due to this reason, a kite of single plane is provided with a negative camber. It should, however, be noted that while [symbol] wings or sweep-back wings of specific arrangements might form exceptions, explanations thereof will be omitted here (Reference: B. Etkin & L. D. Reid, “Dynamics of Flight”, P.23).

2.3 Characteristics of Classical Kites

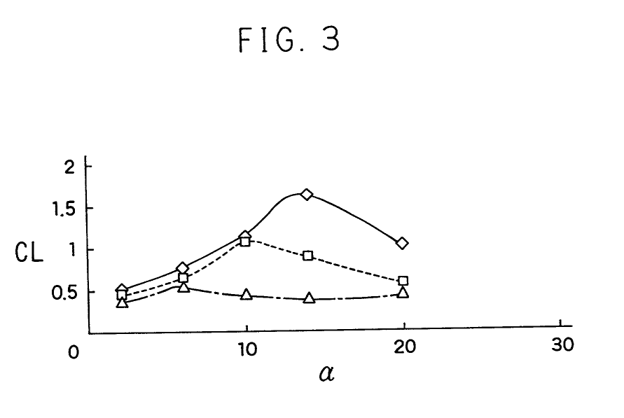

Classical kites are considered to be those comprising of a single plane of negative camber such as Japanese kites or Dutch kites. Characteristics of classical kites of negative camber will now be considered. A relationship between angle of incidence and lifting force in case f=0.01, f=0, and f=−0.01 is satisfied, respectively, is shown in FIG. 3 wherein the lifting force CL is taken on the vertical axis and the angle of incidence a on the lateral axis. In the drawing, the solid line denotes the case of f=0.01, the broken line f=0, and the one dot chain line f=−0.01. The following points are evident from this drawing.

(1) In all of the cases, there exists an angle of incidence at which the lifting force becomes a maximum value. In case this angle of incidence is exceeded, the lifting force promptly decreases. This condition in which the lifting force is decreased is called a stall condition.

(2) The maximum lifting force is small in case of a negative camber.

In a stall condition, the streamline in the periphery of the wing is disturbed so that the lifting force is decreased, and the wind pressure is applied to the plane in a vertical manner. Since f is negative, the kite cannot achieve sufficient lifting force in a laminar region in which the angle of incidence is small. Thus, no lifting force can be achieved in case the kite is lifted with the bridle taken at a point which is comparatively close to the front edge and with the angle of incidence being small (see FIG. 1). Consequently, resistance actuating on the string of the kite becomes predominant so that the kite is drifted and flies low. Kites in such conditions are called ceiling kites, and this is a most disliked flying condition for classical kites.

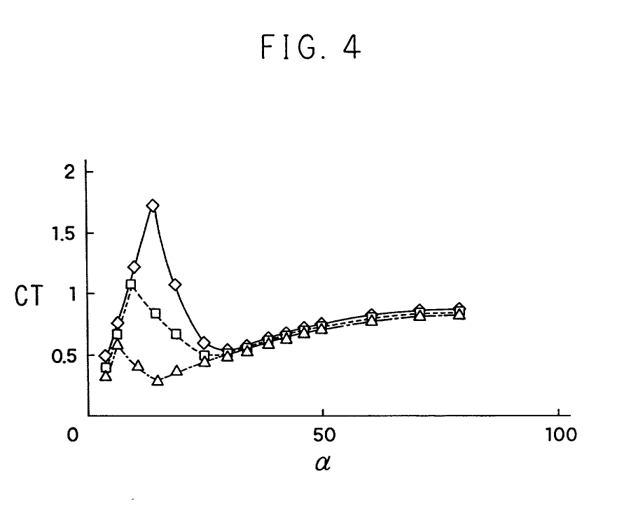

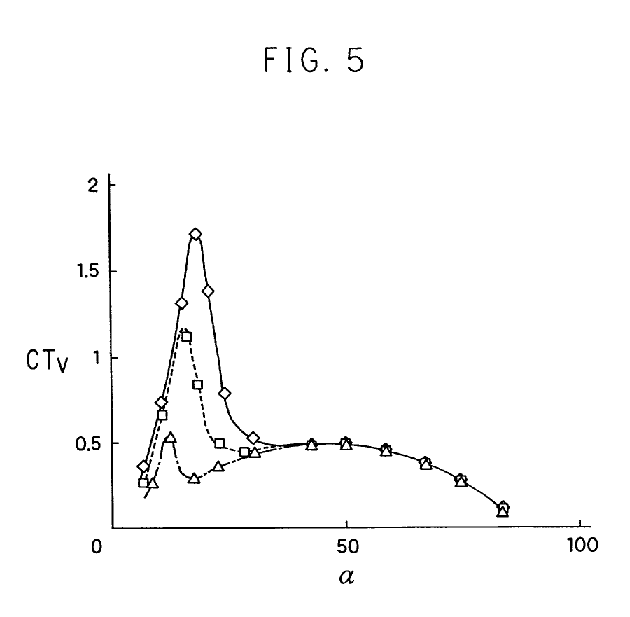

Let us now consider what happens in case the bridle is set closer to the aerodynamic center and the angle of incidence is increased for avoiding occurrence of such ceiling kites. FIG. 4 shows a view in which the wind pressure coefficient CT is plotted as a function of the angle of incidence α in a wider range thereof, and FIG. 5 in which the vertical directional component CTᵥ of the wind pressure coefficient CT is plotted as a function of the angle of incidence. A proper lifting force and a large resistance is achieved in case the angle of incidence is approximately 45°. Lifting classical kites might be interpreted as performing a tug of war with a person at a low elevation angle in this range.

2.4 Theory of the NFO

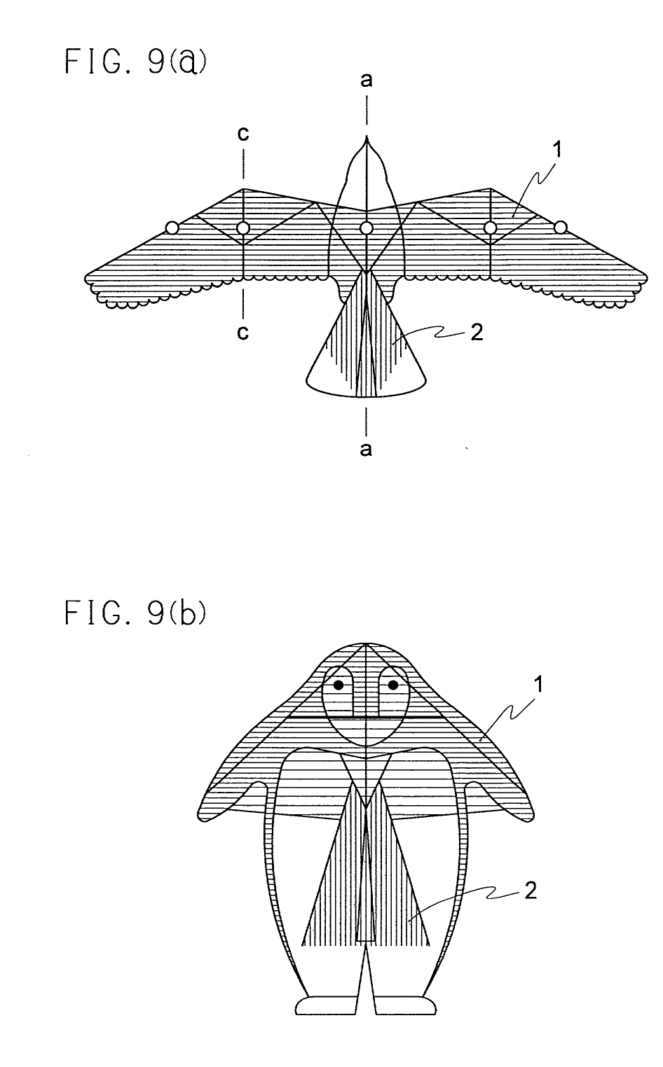

It is the purpose to make the NFO fly by utilizing, as much as possible, the degree of freedom of planar shape which is allowed to a flying object being restricted by a string, by setting the camber of a sectional shape of a plane having an arbitrary planar shape to zero or positive, and by utilizing high lifting force in a laminar region owned by the plane of this type. The static instability related to the pitching owned by the plane of this type is eliminated by employing a framework in which a part of a plane forms main wings and another part of a plane which is most downstream with respect to the wind pressure center of the main wing forms horizontal tails. In FIG. 9 which will be discussed later, the planar shapes correspond to a shape of a seagull and a penguin, respectively, and the hatched portions in the lateral direction of the drawings indicate the main wing portions and the hatched portions in the longitudinal direction the tails. The tails assume negative angles of incidence with respect to zero lifting force lines of the main wings, similarly to airplanes or gliders.

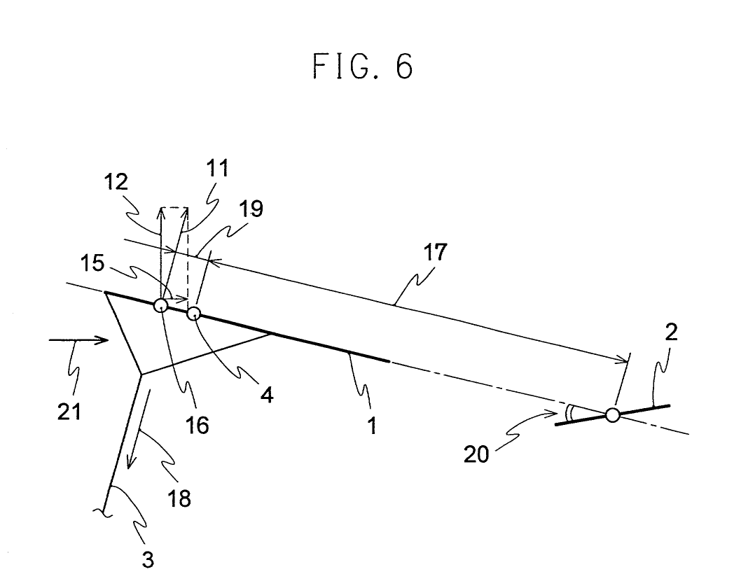

FIG. 6 is a diagram for explaining a flying theory of a flying object with a holizontal tail. 2 denotes a horizontal tail, 4 aerodynamic center, 17 nondimensional distance from aerodynamic center to the center of lifting force of the tail (ht), 18 tension of the string, 19 nondimensional distance from aerodynamic center to the center of wind pressure (X), 20 negative angle of incidence (i), 21 direction of wind respectively.

Effects of the tails will be explained in case f=0 and f=0.01 are satisfied. The area of the wing is indicated by S, the area of the tail by St, and the nondimensional distance from the aerodynamic center to the center of lifting force of the tail (distance/wing arc) by ht. The tail portions assume negative angles of incidence i with respect to the zero lifting force lines of the main wings, and the lifting force coefficients of the tails are set to be equal to those of the main wings. Further, the flow at the tail portions is considered to be along the zero lifting force lines of the main wings.

By the addition of the tails, the Equation 1 for obtaining lifting force of the main wings and the Equation 2 for obtaining moment of aerodynamic center are respectively changed as follows.

CL=2π(Sin (α)−(St/S) Sin (i)+2f) (Equation 6)

Cmac=−πf+2πht(St/S) Sin (i) (Equation 7)

On the other hand, since the center of wind pressure is given by −CLx=Cmac, the following equation for obtaining x can be given by assigning the above Equations 6 and 7.

x=(2ht(St/S) Sin (i)−f)/(2(Sin (α)−(St/S) Sin (i)+2f) (Equation 8)

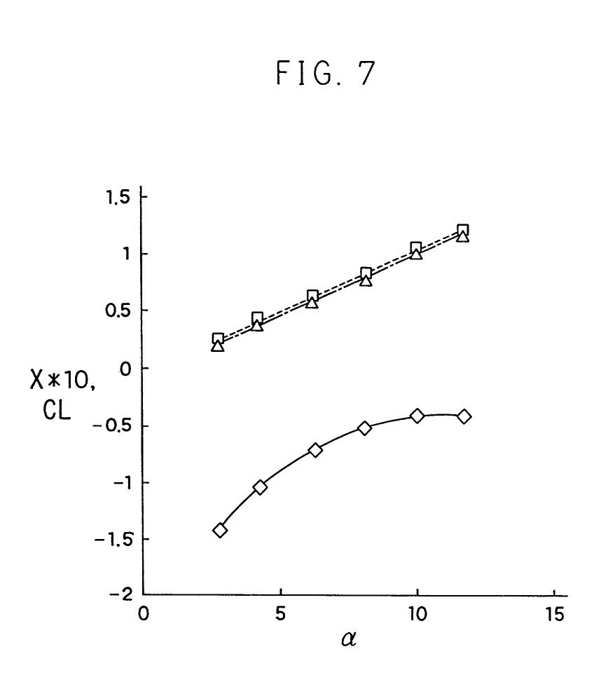

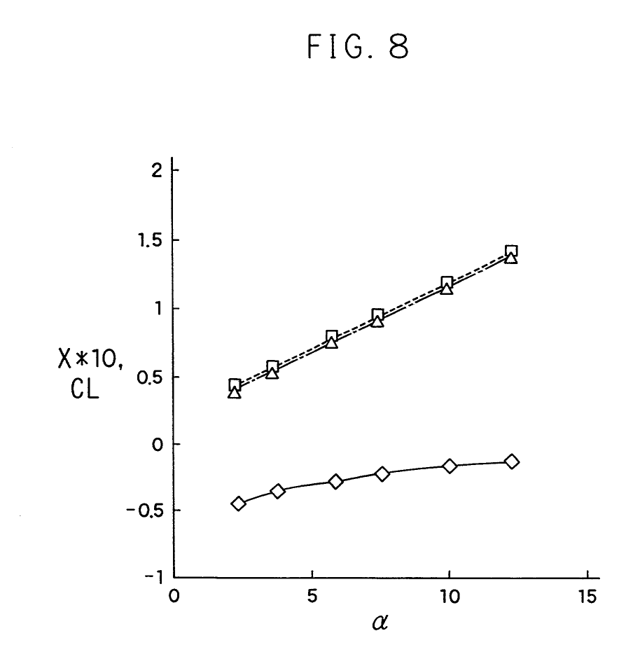

FIGS. 7 and 8 are diagrams showing the lifting force (wherein CL is indicated by the broken line and one dot chain line) and the position of the center of wind pressure (center of bridle) (x multiplied by 10 indicated by the solid line) in relation with the angle of incidence (α) in case i=2°, St/S=0.1 and ht=2 is satisfied. It is evident from these drawings that in both cases in which f=0 (FIG. 7) and f=0.01 (FIG. 8) is satisfied, x<0 is satisfied, that is, the center of wind pressure is closer to the front edge than the aerodynamic center, or the angle of incidence is increased, static stability of pitching is achieved through restoring force since this position is moved closer to the aerodynamic center, that is, in a direction of the rear edge whereby a head-descending moment is actuated to recover the angle of incidence. As for the lifting force, it is presented a superior characteristics that the lifting force in the presence of tails (as indicated by broken line) is hardly varied than compared to lifting force in the absence of tails (as indicated one dot chain line). As explained so far, the flying object of the present invention has enabled it to realize optimization free of losses of required functions as a kite by setting the camber of the main wings to zero or positive without aiming for stability of pitching thereby but only for maximum lifting force, by providing stability of pitching through a negative angle of incidence of the horizontal tail, and further by omitting the designing task of minimizing the resistance.

It has been proven through aircraft dynamics that the above phenomena are realized regardless to planar shapes such as aspect ratios of planes. It should be noted that the point of gravity in airplanes corresponds to the position of the bridle.

2.5 Structure of the NFO

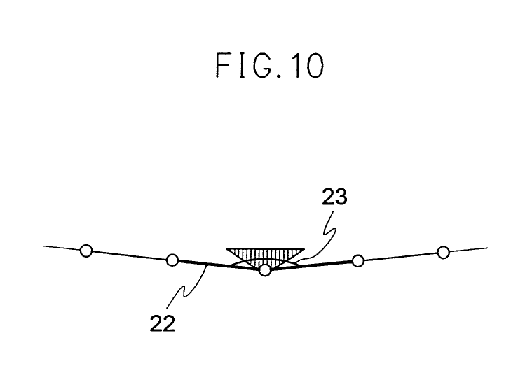

Examples for the planar shape and the framework of the flying object are shown in FIG. 9 and FIG. 10. Birds, insects or bats which fly in nature suggest good examples for planar shapes that one might wish to create as flying objects. On the other hand, penguins, fishes or animal as seen from the front are alternative examples of shapes one might wish to let fly in terms of unexpectation since they do actually not fly in nature. After all, it is worth trying shapes of small aspect ratios which are no applicable in airplanes in view of performance, since a large lifting force might be provided when applied as a shape of the NFO.

The thin-plate structure of the flying object is composed of nonwoven cloth presenting high tension-shock strength with a small weight per area (not more than 40 g/square meter) and sticks of bamboo or organic complex materials (complex materials of carbon fiber or glass fiber) which are light-weighted and present high rigidity. In case of using such materials, it is practical that the size of the plane be not more than 0.2 square meter which corresponds to either 2 or 4 nonwoven cloths of DIN A4 size put together, and the diameter of the round sticks be in the range of 0.2 to 2 mm. In case of employing bamboo sticks which is a natural material, it will be effective to employ an arrangement in which two sticks are pasted together with the bark portions facing outside to prevent bends. Utilizing those materials in an effective manner, it will be possible to obtain a flying plane of 0.2 square meter, wherein the wing arc of the main wings is not more than 20 cm and the area density σ is not more than 60 g/square meter.

As explained above, since the lifting force L of the flying object is given by CL×(1/2)ρU²S (as introduced from Equation 3), U>SQRT (2 σg/ρ)≈ 1 m/s will be satisfied in case the lifting force coefficient is set to be 1, the gravitational acceleration g to 9.8 and the density of air ρ to 1.2, which means that this flying object can be lifted also at a wind speed of 1 m/s. Further, by employing a framework as it will be explained later, it is made possible for the above light-weighted kite to bear a strong wind of 10 m/s.

It is evident from the above that the opportunity of daily performing experiments with the NFO of the present invention is enabled without the necessity of especially selecting a windy day or the necessity of avoiding strong wind.

Manufacturing of the NFO might be performed, for instance, by creating a shape for the plane on the personal computer (PC), by performing printing thereof with a ink jet printer onto 2 or 4 nonwoven cloths of DIN A4 size, and performing cutting and pasting of these to form a single plane. FIG. 9 shows examples of figures. These figures are generally symmetric unless especially elaborated. In the drawings, hatched portions in the lateral direction correspond to main wings and those in the longitudinal direction to tails. It should be noted that a front edge portion of the figure that receives a large wind pressure should preferably be of simple shape which might be approximated through a single or several broken lines in view of the fact that a flying object shall be obtained.

The arrangement of the NFO will be explained with reference to FIG. 9. In case carbon fiber is employed for the framework of the NFO, two types of frames, namely thick frames (1.4 φ to 1.6 φ in case of a sheet size corresponding to DIN A4×4) and thin frames (0.8 φ to 1.0 φ). First, the thin frames are adhered in the following order on the rear side of the plane.

(1) Onto central line (a-a) of a symmetric figure.

(2) Onto lines (c-c) parallel to the central line and located approximately in the center of the right and left portions in case of a figure extending in lateral directions as the bird in FIG. 9.

(3) Several frames in the proximity of the front edge.

(4) Reinforcing through several thin frames a portion which exceeds the front edge as shown in the figure of the penguin.

(5) Diagonally extending from the thin frame of the front edge to line (a-a) and line (c-c).

(6) Outer edge of the tail.

It is preferable that the frame materials are arranged like triangles put together as above explained. This is because an arrangement in which rectangles are put together will not be able to prevent distortion which is fatal to flying objects. By arranging the thin frames in the above manner, the planar arrangement of the flying object can be completed. It should, however, be noted that lines (a-a) and (c-c) are still bendable in this condition.

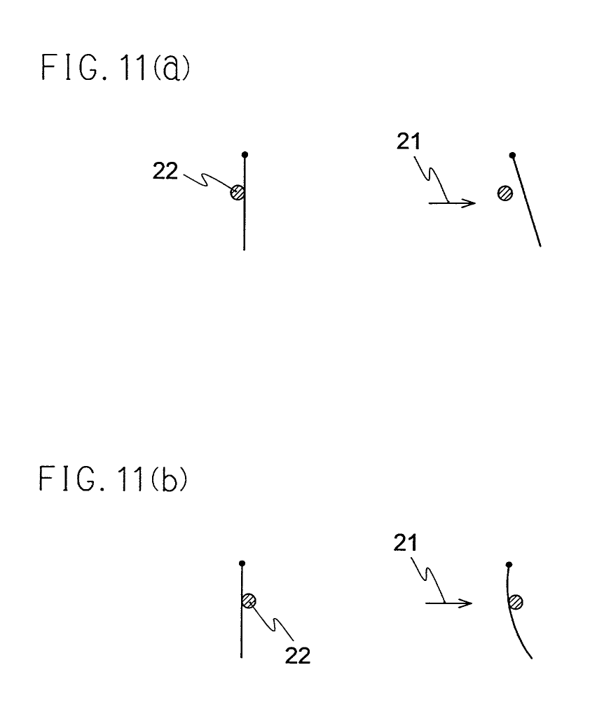

Next, main frames 22 obtained by connecting thin frames to both end portions corresponding to intersections with line (c-c) are provided in case of configuring a bird, and these main frames are connected to the thin frames on the upper surface of the plane at connecting points (circles) as shown in FIG. 9. The right and left main frames are connected through springs 23 as shown in FIG. 10. The reason for connecting the main frames 22 to the front surface of the sheet is that a negative camber of the sheet shall be prevented. In case the main frames are pasted on the rear surface of the sheet as shown in arrangement of FIG. 11(b), a negative camber will be created by the wind 21 as shown in the drawing. However, by arranging the same on the front surface without pasting it to the sheet as in arrangement of FIG. 11(a), the sheet will not form a negative camber. In FIG. 11(a) and FIG. 11(b), the drawings on the left side mean conditions with no wind while those on the right side mean conditions under wind. Further, in order to prevent the line (a-a) and line (c-c) from being bent in a form of a ship bottom and thus to form negative cambers, diagonally placed frames are inserted between these lines and the frame at the front edge to increase the rigidity of a portion of the sheet at which these frames are attached while these planes are allowed to be bent upon receipt of wind.

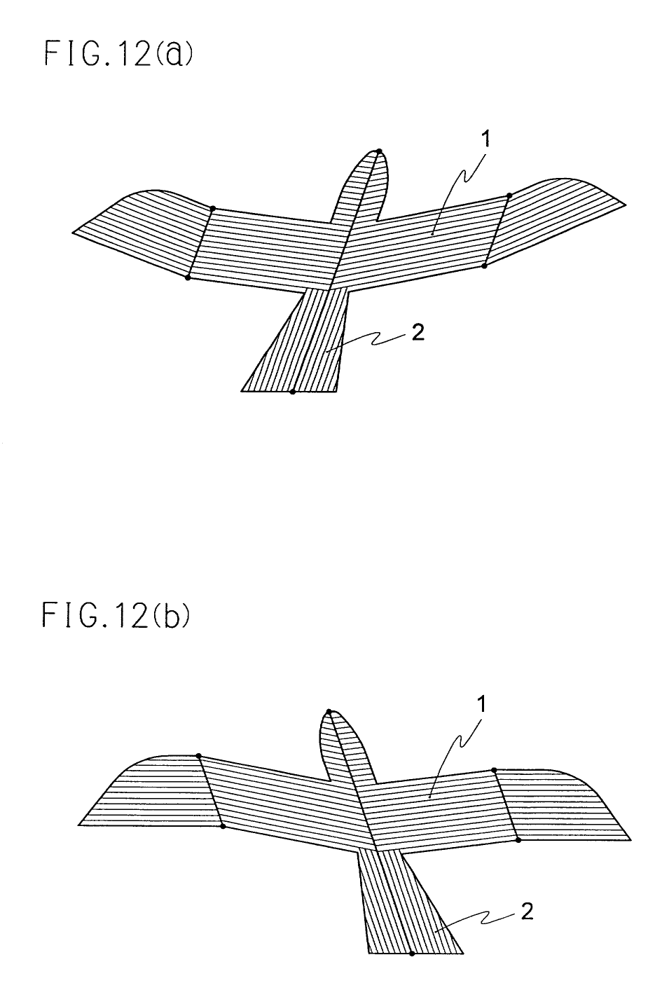

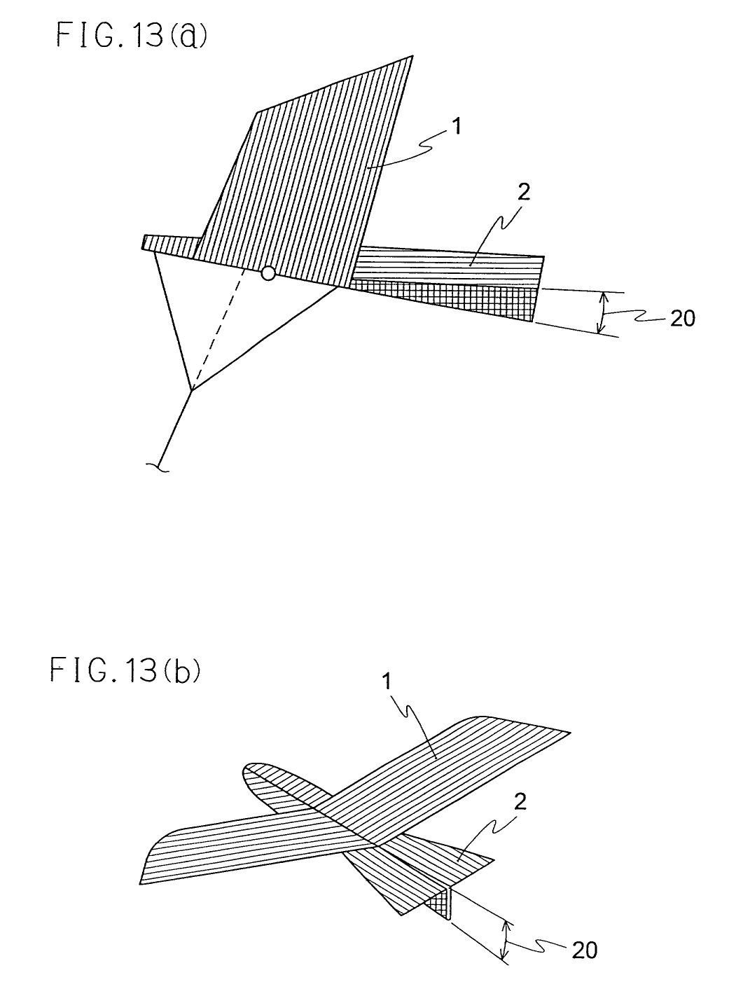

In FIG. 12, there are shown conditions in which these planes are bent into two due to a strong wind. Through the provision of thin frames at edge lines of the rigid plane bent into two as shown in the drawings, the rigidity of the edge lines is quite high and there is no fear that these might be bent in a shape of a ship bottom no matter how strong the wind might be. Especially the central line (a-a) that is provided with the bridle as shown in FIG. 12 and FIG. 13 presents even higher rigidity.

FIG. 13 indicates an example of a method for forming the tail. As shown in FIG. 13, in case a triangle portion which extends over the central line and is widened in a rear direction is folded along the central line and is pasted together, the aforementioned negative angle of incidence 20 (i) can be formed. Through the crosshatched portion in the drawing obtained by the pasting, it is possible to create a vertical tail which is effective in keeping the direction of the kite to the direction of wind. It should be noted that it is known for the phenomenon in which a negative angle of incidence is formed through the wind pressure during the flying condition by simply making the rigidity of the horizontal tail portion low instead of positively creating a negative angle of incidence for the horizontal tail. It is also possible to utilize this phenomenon in actually manufacturing a kite.

2.6 Characteristics of the NFO as a Teaching Material

(1) Simultaneous acquisition of creativity and knowledge on mechanical engineering: In a study employing the NFO as a teaching material, students are made to create an arbitrary figure that they wish to make fly, to fully use knowledge over a wide field of mechanical engineering (hydrodynamics, materialistic dynamics, control engineering, etc.) and to create a structure for the flying object to provide best performances for a kite. Consequently, students do not only acquire knowledge of mechanical engineering over a wide range but also acquire creativity.

(2) Acquisition of application of PCs: since the NFO utilizes laminar region, theoretical hydrodynamic equations which are the most complicated ones among the techniques required for the design of the NFO can be expressed by analytic functions. Thus, all of the technical knowledge can be described through programs such as Mathematica or Mathcad. Consequently, it is enabled that students acquire technical knowledge without the necessity of performing time-consuming mathematical calculations in which errors are apt to occur.

(3) Since all of the equations are described through programs such as Mathematica or Mathcad unlike conventional methods in which they are written on paper, it is enabled that students not only consider various problems concerning harmonizing conditions, static stability or dynamic stability of the flying objects in a quantitative manner but also simulate actual behavior on the PC after the acquisition.

(4) Results of the study can be confirmed through experiments. Consequently, students can learn a lot about the significance of experiments.

3. Structure of the Hydrodynamic Simulation Program

The hydrodynamic simulation program employed in the technical educational system of the present invention includes the following functions. Based on basic equations of hydrodynamics, especially aircraft dynamics, behaviors of a moving object can be simulated wherein the moving object might be an airplane. Further, arrangements of models each reflecting a variety of conditions for restriction such as kites, airplanes or gliders can be simulated. It also includes an interfacial function for effectively performing input of structural conditions and output of flying conditions for the kite. The output functions include display of actual time for the flying movements of the flying object, display of time functions or display of parameter functions as indices of flying conditions, or display of action and effects of design parameters. This simulation program also includes a wind simulator for simulating variously varying wind in natural environments. By the provision of such a simulator, computational simulation of experiments for actually making imagined examples for the design of the kite fly in natural environments is made possible. Since the flying object of the present invention performs flying through laminar conditions, simulation of flying can be treated as an analytic function so that detailed analysis can be performed with a small-sized computer (PC) in a short time. Further, it also has a function as a textbook so that students can efficiently study hydrodynamics by simulating the flying object as a teaching material.

4. Details of Learning Using A Teaching Material

(1) Hydrodynamic, especially aircraft dynamic functions owned by the flying object as a teaching means can be understood through computational simulations.

It is effective to repeat operations of varying arrangements of the flying objects and of confirming changes in flying characteristics through these variations.

(2) Manufacture of the Flying Object

Using the knowledge that one has acquired through simulation, a flying object is designed and manufactured. Various alternatives of the flying object are manufactured that are within a range in which basic structural conditions are met. It will be of benefit in case each of a plurality of students manufacture alternative flying objects which are different from each other whereby a large variety of alternatives can be obtained.

(3) Test Flying of Flying Objects

Test Flying of the manufactured flying objects as kites is performed outdoors. Through performing comparison of characteristics of flying actions of each of the alternative flying objects, it is aimed for understanding of the relationship between the variations and flying characteristics. Following the steps that will now be explained as an example of steps for learning will support efficient learning.

Hypotheses are set which can explain differences in flying characteristics of alternative flying objects which have been obtained through experiments, and properness of these hypotheses is confirmed by manufacturing alternative flying objects of which characteristics corresponding to the hypotheses have been exaggerated and by performing test flying thereof. Verification of the relation between variation and hypothesis is attempted for each portion of the flying object. By putting together multiple hypotheses, it is aimed to find a direction for improving the flying performance to reflect it for the design of a flying object. Then, manufacturing and test flying of the improved flying object is performed.

Understanding and knowledge that have been obtained through the above experiments is represented through simulation to confirm points of recognition. Since flying characteristics can be confirmed by simulation without being affected by instabilities in natural environments, improvements of flying performance can be efficiently performed through combining these points with those obtained through experiments in a mutually supplementing manner.

By experiencing the above processes, it is enabled to deeply comprehend the theory of hydrodynamics. The comprehension of the theory can be further raised to a high level which might lead to autonomous intellectual creative actions of creating a flying object of improved flying performance.

### EMBODIMENT 2

In an experiment with a flying object of an alternative embodiment, conditions are additionally set for making the flying object glide as a glider wherein no string is used, and wherein a weight is added on the most front portion of the flying object and the gravity thereof is set to be closer to the front than the drifting center. Test gliding of this flying object is performed in air in a wind-less condition. Through this experiment, it is possible to get an understanding of another aspect of flying functions of a kite. It can be recognized that in case of objects of which wing shapes are identical, the one of better gliding performance also presents better flying performance when it is made to fly as a kite. However, the one which presents favorable flying performance as a kite does not necessarily present favorable flying performance as a glider, whereby it can be recognized of differences between the flying object of the present invention and a glider or an airplane.

According to the method of technical education of the present invention, creative activities for obtaining an improved flying object can be performed during an educational process of experiencing effective and proper designing, manufacturing and test flying of a flying object as a teaching material. With this arrangement, the level of comprehension of hydrodynamics can be heightened from a level of passive comprehension to a level with which intellectual productive activities in the sense of creative activities can be achieved.

What is claimed is:

1. A method of technical education comprising
(a) an educational process of simulating behaviors of a flying object through a simulation program of flight functions based on basic equations of hydrodynamics,
(b) an educational process of designing the flying object and manufacturing the same,
(c) an educational process of confirming behaviors of the flying object through experimentation, and
(d) an educational process of optimizing the flying object to present targeted functions.

2. A system of technical education comprising
(a) a simulation program for analyzing behaviors of a flying object based on basic equations of hydrodynamics,
(b) an executing means for executing the simulation program for analyzing behaviors of the flying object, and
(c) a manufacturing means for manufacturing a physical functional system being oriented to the flying functions.

3. A flying object as a physical teaching material comprising a sheet-like planar constitutional material and a frame material, and being of planar arrangement that can maintain its own shape, the flying object having main wings and at least horizontal tails assuming negative angles of incidence, in which at least the main wings assume dihedral angles and a tension center of string at the time of making the object fly as a kite is positioned closer to the front than the aerodynamic center.
